(19) United States
(12) Patent Application Publication
(10) Pub. No.: US 2010/0288747 A1
(43) Pub. Date: Nov. 18, 2010

(54) CERAMIC HEATER AND GLOW PLUG PROVIDED THEREWITH

(75) Inventor: Ken Yamamoto, Kirishima-shi (JP)

Correspondence Address: Hogan Lovells US LLP, 1999 AVENUE OF THE STARS, SUITE 1400, LOS ANGELES, CA, 90067, US

(73) Assignee: KYOCERA CORPORATION, Kyoto (JP)

(21) Appl. No.: 12/740,676

(22) PCT Filed: Oct. 28, 2008
(86) PCT No.: PCT/JP2008/069559

§ 371 Date: Aug. 4, 2010

(30) Foreign Application Priority Data
Oct. 29, 2007 (JP) 2007-280902

(51) Int. Cl. F23Q 7/22; H05B 3/10

(52) U.S. Cl. 219/270; 219/548

(57) ABSTRACT

The ceramic heater comprises a heating resistor that includes opposing portions disposed side by side, a pair of lead members connected to ends of the heating resistor, and a ceramic base in which the heating resistor and the lead members are embedded, wherein a high heat conductivity member that has a heat conductivity higher than that of the ceramic base is disposed between the opposing portions in the ceramic base.

### TECHNICAL FIELD

The present invention relates to a ceramic heater and a glow plug that is provided with the ceramic heater.

### BACKGROUND ART

Ceramic heaters have been used in various applications including an ignition heater for kerosene burning fan heaters. The ceramic heater comprises, for example, a U-shaped heating element that is, together with lead members that are connected therewith at the ends thereof, embedded in a bar-shaped insulating substrate (refer to, for example, patent Document 1).

Patent Document 1: Japanese Unexamined Patent Publication (Kokai) No. 2006-49279

### DISCLOSURE OF THE INVENTION

### Problems to be Solved by the Invention

However, the conventional ceramic heater described above has a problem that temperature distribution of a ceramic base 64 in the circumferential direction thereof is not necessarily uniform, as shown in cross sectional view of the ceramic heater of FIG. 7. Specifically, a rate of heat transfer is high in the direction of line that connects the opposing portions 62, 63 of the heating element that are disposed side by side (toward regions H), while a rate of heat transfer is low in a direction perpendicular to the above-mentioned direction (toward regions C), in the cross section.

### MEANS FOR SOLVING THE PROBLEMS

A ceramic heater of the present invention comprises a heating resistor that includes opposing portions disposed side by side, a pair of lead members connected to ends of the heating resistor, and a ceramic base in which the heating resistor and the lead members are embedded, wherein a high heat conductivity member that has a heat conductivity higher than that of the ceramic base is disposed between the opposing portions in the ceramic base.

In the ceramic heater of the present invention having the constitution described above, it is preferable that the high heat conductivity member is in contact with at least either one of the opposing portions.

In the ceramic heater of the present invention having the constitution described above, it is also preferable that the high heat conductivity member is disposed to extend along the longitudinal direction of the opposing portions.

In the ceramic heater of the present invention having the constitution described above, it is also preferable that the high heat conductivity member includes ceramics as the main component.

In the ceramic heater of the present invention having the constitution described above, it is also preferable that the high heat conductivity member includes the same material as that of the opposing portions as the main component.

In the ceramic heater of the present invention having the constitution described above, it is more preferable that the high heat conductivity member makes contact with the opposing portions, and that the minimum distance between the high heat conductivity member that extend from the opposing portions is 0.3 mm or more.

A glow plug of the present invention is characterized in that the ceramic heater having the constitution described above is provided.

### EFFECTS OF THE INVENTION

The ceramic heater of the present invention is excellent in uniformity of the temperature distribution in the circumferential direction of the ceramic base in the cross section thereof, because the high heat conductivity member having heat conductivity higher than that of the ceramic base is disposed between the opposing portions in the ceramic base.

### BEST MODE FOR CARRYING OUT THE INVENTION

The ceramic heater according to one embodiment of the present invention will be described in detail below with reference to the accompanying drawings. FIG. 1(a) is a perspective view showing the ceramic heater according to the embodiment, and FIG. 1(b) is a sectional view taken along lines X-X in FIG. 1(a).

The ceramic heater 100 of this embodiment comprises a heating resistor 10 that includes the opposing portions 10b, 10c disposed side by side, a pair of lead members 11, 12 connected to ends of the heating resistor 10, and the ceramic base 2 in which the heating resistor 10 and the lead members 11, 12 are embedded. The heating resistor 10 has U shape constituted from the opposing portions 10b, 10c and a connecting portion 10a that connects therebetween. The heating resistor 10 generates heat when electric current is supplied through the lead members 11, 12 to the heating resistor 10.

In this embodiment, the lead members 11, 12 are formed from a material similar to that of the heating resistor 10, integrally with the opposing portions 10b, 10c in substantially the same direction, with thickness larger than that of the heating resistor 10 and resistance per unit length lower than that of the heating resistor 10. End of the lead member 11 on the side thereof opposite to the end connected to the heating resistor 10b is exposed on the end face of the ceramic base 2, so as to form an electrode lead-out section 11a. End of the lead member 12 on the side thereof opposite to the end connected to the heating resistor 10c is exposed on the side face of the ceramic base 2, so as to form an electrode lead-out section 12a.

FIG. 2(a) is an enlarged sectional view schematically showing the heating resistor 10 shown in FIG. 1(b), and FIG. 2(b) is a sectional view schematically showing the ceramic heater 100 in the section taken along lines Y-Y in FIG. 2(a). As shown in FIG. 1(b) and FIGS. 2(a), 2(b), the ceramic heater 100 has a high heat conductivity member 21 that has a heat conductivity higher than that of the ceramic base 2 disposed between the opposing portions 10b, 10c of the heating resistor 10 in the ceramic base 2. This constitution of the ceramic heater 100 of this embodiment makes it easier for heat E generated by the heating resistor 10 to be transmitted to the vicinity of the high heat conductivity member 21 as indicated by double dot and dash line in FIG. 2(b), than in the case of the conventional ceramic heater that is not provided with the high heat conductivity member. As the heat E is transmitted to the region C that tends to become lower in temperature in the prior art, uniformity of temperature distribution in the circumferential direction of the ceramic base 2 in the cross section thereof is improved.

It is preferable that the high heat conductivity member 21 makes contact with at least one of the opposing portions 10b, 10c. As the high heat conductivity member 21 makes contact with at least one of the opposing portions 10b, 10c, transmission of the heat E from the opposing portions 10b, 10c of the heating resistor 10 to the high heat conductivity member 21 is improved so that heat transmission to the region C is also improved and, as a result, uniformity of temperature distribution in the circumferential direction of the ceramic base 2 in the cross section thereof is further improved.

It is also preferable that the high heat conductivity member 21 is disposed to extend along the longitudinal direction of the opposing portions 10b, 10c. As the high heat conductivity member 21 is disposed to extend along the longitudinal direction of the opposing portions 10b, 10c, uniformity of temperature distribution may be further improved in the portion of the ceramic base 2 that covers the heating resistor 10.

Materials preferably used to constitute the ceramic heater 100 will be described below.

The heating resistor 10 may be formed from a known electrically conductive ceramics such as tungsten carbide (WC), molybdenum disilicate (MoSi₂) or tungsten disilicate (WSi₂)

A case of using tungsten carbide will be described as an example. A WC powder is prepared. It is preferable that the WC powder has an insulating ceramics such as silicon nitride ceramics or alumina ceramics that is used as the main component of the ceramic base 2 added thereto in order to decrease the difference in thermal expansion coefficient from the ceramic base 2. Electric resistance of the heating resistor 10 may be controlled to a desired value by adjusting the proportions of the insulating ceramics and the electrically conductive ceramics.

While the heating resistor 10 may be formed by pressing a ceramic material powder prepared by adding silicon nitride ceramics or alumina ceramics that is the main component of the ceramic base 2 to the WC powder by a known press molding process, it is preferable to employ the injection molding process that allows it to freely determine the configuration along with the die, as will be described later.

While the material that constitutes the ceramic base 2 is preferably alumina-based ceramics or silicon nitride-based ceramics for the reason of favorable insulating characteristic at high temperatures, it is particularly preferable to use silicon nitride-based ceramics because it has high durability during quick heating. Silicon nitride ceramics has such an internal structure as grains of main phase consisting mainly of silicon nitride (Si₃N₄) are bonded together by a grain boundary phase originating from sintering aid or the like. In the main phase, part of silicon (Si) or nitrogen (N) may be substituted with aluminum (A1) or oxygen (O), or even a solid solution of metal atoms such as Li, Ca, Mg or Y may be formed in the main phase. While the ceramic base of this embodiment may be formed by pressing a ceramic powder prepared by adding a sintering aid consisting of oxide of a rare earth element such as ytterbium (Yb), yttrium (Y) or erbium (Er) to a silicon nitride powder by a known press molding process, it is preferable to employ the injection molding process that allows it to freely determine the configuration along with the die.

The high heat conductivity member 21 may be formed from a material that has heat conductivity higher than that of the ceramic base 2. In case the high heat conductivity member 21 is formed from an insulating material, it is made possible to suppress short circuiting even if the width W1 of the high heat conductivity member 21 (FIG. 2) is increase to about the same size of the distance between the opposing portions 10b and 10c, and also uniformity of heating may be improved as the width W1 is increased. The insulating material may be, for example, AIN, BN, SiC, diamond or a carbon compound. In case the high heat conductivity member 21 is formed from the same material as that of the opposing portions 10b and 10c, the manufacturing cost may be reduced since the manufacturing process may be simplified.

The width W1 of the high heat conductivity member 21 is preferably from about 0.1 to 1 mm, and more preferably from about 0.3 to 0.5 mm. Minimum distance W2 between the high heat conductivity member 21 and the opposing portion 10b (10c) is preferably 0.3 mm or more, and more preferably 0.5 mm or more, in order to suppress short circuiting from occurring with respect to the opposing portions 10b, 10c.

An example of a method for manufacturing the ceramic heater 100 according to the embodiment of the present invention will be described below. First, a die for molding the ceramic heater 100 is prepared. The die comprises a first upper die and a first lower die, so that a cavity that corresponds to the shape of the ceramic heater 100 is formed when the first upper die and the first lower die are mated with each other. With a green compact that would become the high heat conductivity member 21 and a green compact that would become the heating resistor 10 being placed at a desired position in the die, material of the ceramic base 2 may be supplied into the die by injection molding process.

FIG. 3(a) is an enlarged sectional view schematically showing the heating resistor 10 of the ceramic heater according to another embodiment of the present invention, and FIG. 3(b) is a sectional view schematically showing the ceramic heater taken along lines Z-Z in FIG. 3(a). As shown in FIGS. 3(a) and 3(b), the high heat conductivity member 23 of this embodiment is connected to (in contact with) the opposing portions 10b, 10c, and extends from the opposing portions 10b, 10c toward the center of the ceramic base 2. The high heat conductivity member 23 also extends along the longitudinal direction of the opposing portions 10b, 10c.

Providing the high heat conductivity member 23 makes it easier for heat generated by the heating resistor 10 to be transmitted to the region located between the opposing portions 10b, 10c than in the case of the conventional ceramic heater that is not provided with the high heat conductivity member 23. As the heat is transmitted to the region C that is apt to become lower in temperature in the prior art, uniformity of temperature distribution in the circumferential direction of the ceramic base 2 thereof is improved.

The width W3 of the high heat conductivity member 23 is preferably roughly from 0.01 to 0.5 mm, and more preferably roughly from 0.02 to 0.3 mm. Minimum distance W4 between the high heat conductivity members 23 is preferably 0.3 mm or more, and more preferably 0.5 mm or more, in order to suppress short circuiting from occurring with respect to the opposing portions 10b, 10c.

The high heat conductivity member 23 shown in FIG. 3 may have, uneven width (reference numeral 25) as shown in FIG.

4(a). Such an uneven configuration makes the member less likely to resonate with extraneous vibration during operation, thereby improving the durability. High heat conductivity member 27 may also be formed in the region between the opposing portions 10b, 10c and the surface of the ceramic base 2, as shown in FIG. 4(b). In this case, it is preferable that width W3 of the high heat conductivity member 25 is larger than width W5 of the high heat conductivity member 27. This constitution makes it easier for heat generated by the heating resistor 10 to be transmitted to the inside than to the surface of the ceramic heater 100, so that uniformity of heating by the ceramic heater 100 may be improved further. It is more preferable to dispose the high heat conductivity member 25 only between the opposing portions 10b, 10c as shown in FIG. 4(a).

FIG. 5(a) is a sectional view schematically showing the ceramic heater 100 according to further another embodiment of the present invention. In this embodiment, as shown in FIG. 5(a), high heat conductivity member 29 is disposed so as to extend to the vicinity of the regions C, C that are apt to become lower in temperature, and therefore uniformity of heating by the ceramic heater may be improved further. As shown in FIGS. 5(b) and 5(c), high heat conductivity members 31, 33 may not necessarily consist of a single member, and may consist of a plurality of members. In the form shown in FIG. 5(b), a plurality of high heat conductivity members 31 are disposed to run from one region C toward the other region C. In the form shown in FIG. 5(c), a plurality of high heat conductivity members 33 are disposed from one end of the opposing portions 10b, 10c toward the other end (along the longitudinal direction of the opposing portions).

FIG. 6 is a sectional view showing a glow plug according to one embodiment of the present invention. As shown in FIG. 6, the glow plug 101 comprises the ceramic heater 10 described above, a tubular housing 102 that has the former held on the distal end thereof and is mounted on the cylinder head of an engine, and a metallic outer tube 103 that holds the ceramic heater 10 at the distal end of the housing 102. The ceramic heater 10 is brazed onto the metallic outer tube 103, and the metallic outer tube 103 is brazed onto the distal end of the housing 102.

### BRIEF DESCRIPTION OF THE DRAWINGS

FIG. 1(a) is a perspective view showing the ceramic heater according to the embodiment, and FIG. 1(b) is a sectional view taken along lines X-X in FIG. 1(a).

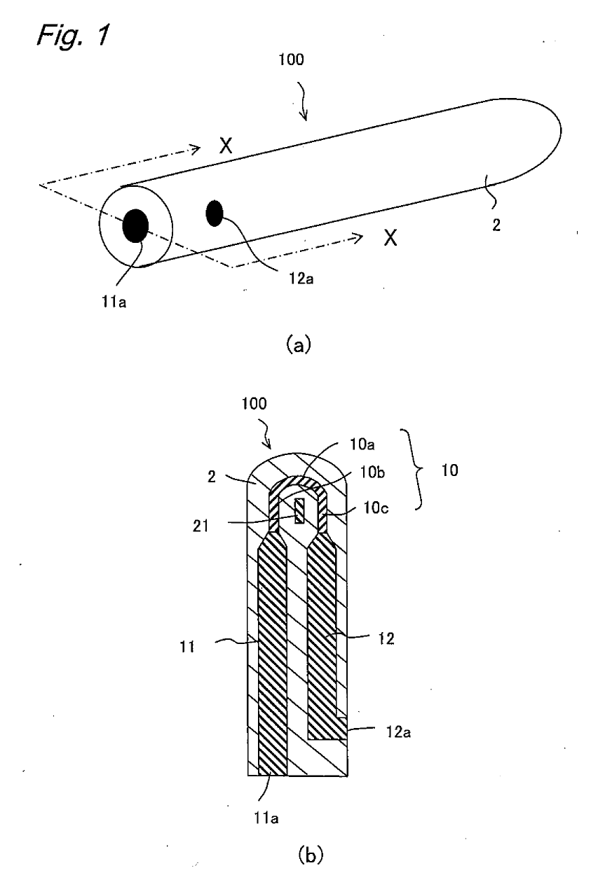

FIG. 2(a) is an enlarged sectional view schematically showing the heating resistor shown in FIG. 1(b) and FIG. 2(b) is a sectional view schematically showing the ceramic heater taken along lines Y-Y in FIG. 2(a).

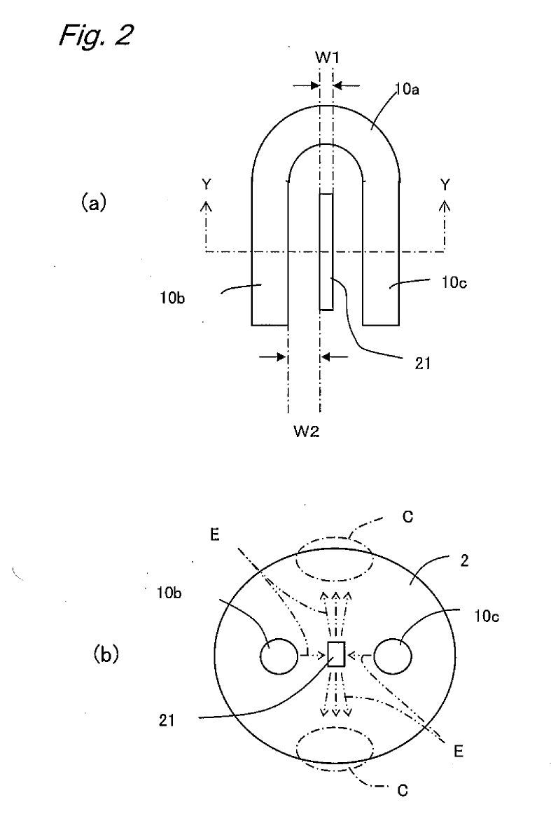

FIG. 3(a) is an enlarged sectional view schematically showing the heating resistor of the ceramic heater according to another embodiment of the present invention, and FIG. 3(b) is a sectional view schematically showing the ceramic heater taken along lines Z-Z in FIG. 3(a).

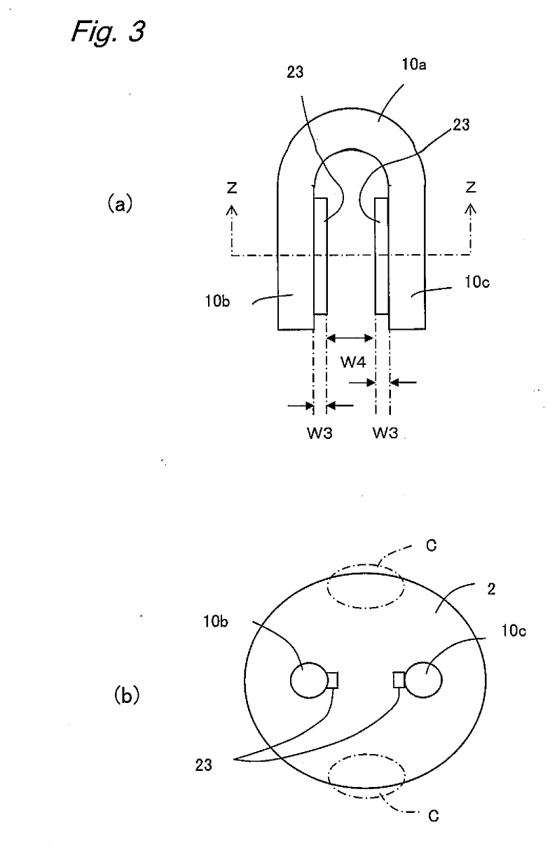

FIGS. 4(a) and 4(b) are schematic diagrams showing variation of the heating resistor.

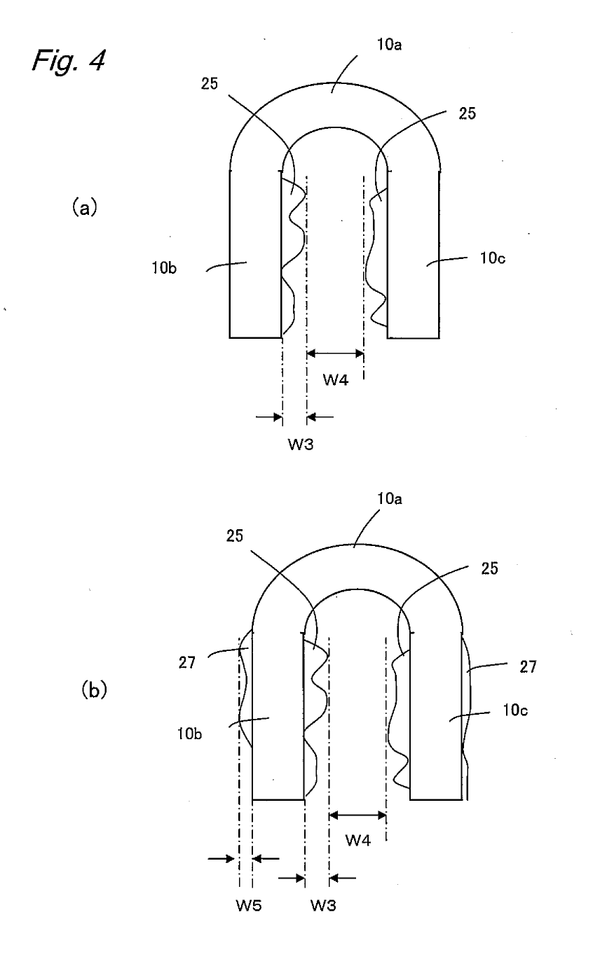

FIGS. 5(a) and 5(b) are cross sectional views schematically showing the ceramic heater according to further another embodiment of the present invention, and FIG. 5(c) is a schematic longitudinal sectional view.

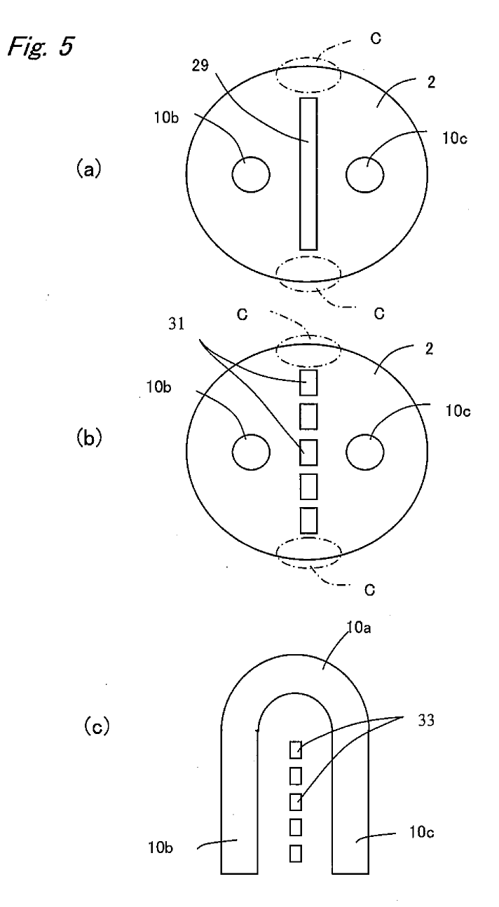

FIG. 6 is a sectional view showing the glow plug according to one embodiment of the present invention.

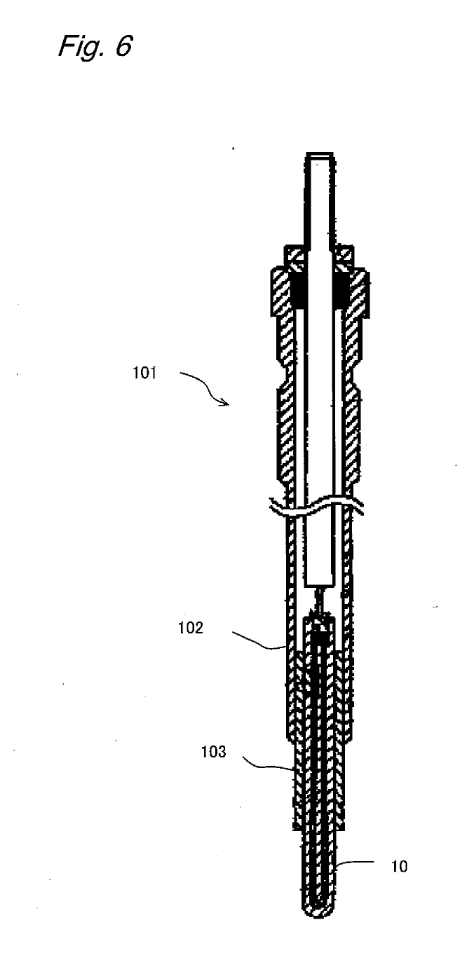

FIG. 7 is a sectional view schematically showing the ceramic heater of the prior art.

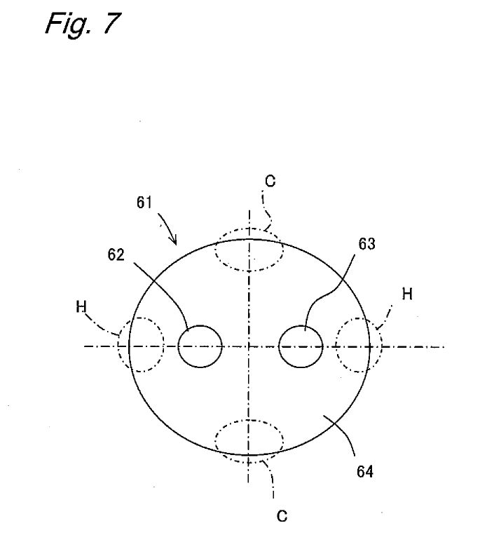

### DESCRIPTION OF REFERENCE NUMERALS

2 Ceramic substrate

10 Heating resistor

10b, 10c Opposing portions

11, 12 Leads

21 High heat conductivity member

100 Ceramic heater

1. A ceramic heater comprising:
a heating resistor that includes opposing portions which are disposed to be opposite to each other;
a pair of lead members connected to ends of the heating resistor; and
a ceramic base in which the heating resistor and the lead members are embedded,
wherein a high heat conductivity member that has a heat conductivity higher than that of the ceramic base is disposed between the opposing portions being in the ceramic base.

2. The ceramic heater according to claim 1, wherein the high heat conductivity member is in contact with at least one of the opposing portions.

3. The ceramic heater according to claim 1, wherein the high heat conductivity member is disposed to extend along a longitudinal direction of the opposing portions.

4. The ceramic heater according to claim 1,
wherein the high heat conductivity member includes ceramics as a main component.

5. The ceramic heater according to claim 1,
wherein the high heat conductivity member includes, as a main component, the same material as that of the opposing portions.

6. The ceramic heater according to claim 1,
wherein the high heat conductivity member makes contact with the opposing portions, and
wherein the minimum distance between the high heat conductivity members is 0.3 mm or more.

7. A glow plug comprising the ceramic heater according to claim 1.
